(19) United States
(12) Patent Application Publication
(10) Pub. No.: US 2020/0330319 A1
(43) Pub. Date: Oct. 22, 2020

(54) PARTNER TOY HAVING MAGNETIC FIELD SENSORS

(71) Applicant: FUN FACTORY GMBH, Bremen (DE)

(72) Inventor: Dirk BAUER, Bremen (DE)

(21) Appl. No.: 16/757,328

(22) PCT Filed: Oct. 19, 2018
(86) PCT No.: PCT/EP2018/078688

§ 371 Date: Apr. 17, 2020

(30) Foreign Application Priority Data
Oct. 19, 2017 (DE) 20 2017 106 343.7

(51) Int. Cl. A61H 19/00; A61H 23/02

(52) U.S. Cl. CPC A61H 19/44; A61H 19/50; A61H 19/34; A61H 23/0218; A61H 2201/0153; A61H 2201/5005; A61H 2201/169; A61H 2201/5025; A61H 2201/5097; A61H 2201/5064; A61H 2201/1207; A61H 2201/165

(57) ABSTRACT

An apparatus for sexual stimulation, having a massage body configured to contact the body of a user, the massage body being surrounded at least in part by a silicone casing. The apparatus includes a vibratory drive in the massage body for causing the massage body to vibrate, a control unit for controlling the vibratory drive, and an energy source for providing electrical energy to the vibratory drive and the control unit. The control unit is adapted for receiving signals or determining data representing a distance from a transmitter partner toy. The control unit is further adapted for controlling the vibratory drive as a function of the distance.

### BACKGROUND

### Technical Field

The invention relates to a partner toy system for use by a couple for sexual activity or sexual stimulation and more specifically, to a receiver partner toy with vibration that is controlled as a function of distance between the receiver partner toy and a transmitter partner toy.

### Description of the Related Art

In practice, many attempts have previously been made to develop a partner toy or partner toy system for use by couples for sexual activity. Previous toys are typically usable by only one person, or intended for only one person, particularly such as conventional vibrators or dildos.

A known partner toy commonly used in practice is known from the company Standard Innovation and is sold under the name We-Vibe. Said toy is described in EP 1 824 440 B1. The toy comprises a U-shaped or C-shaped body having an inner arm sized for inserting into a vagina and an outer arm sized for contacting the clitoral area when the inner arm is inserted into the vagina, wherein the outer arm defines a clitoral pad. The toy further comprises an elastic U-shaped element connecting the inner and the outer arm to each other. The elastic element is thin and narrow in order to enable sexual intercourse when the inner arm is inserted into the vagina, and the inner and the outer arm taper down to the elastic element so that the device is sized overall for being worn by a woman during sexual intercourse. The device is generally C-shaped in design when in a relaxed state, wherein the C-shape of the device is opened during use so that the device is L-shaped in general and a pressure resulting therefrom from an inner arm on the front surface of the vagina and from the clitoral pad on the clitoral area holds the device in place when worn by a woman during sexual intercourse.

Said toy is intended only for the woman, however, and thus is used only for stimulating the one partner. Even for same-sex sexual activity, each person has only her own toy.

Furthermore, a system is known from US 2016/0199249 A1, wherein a plurality of toys can communicate with each other by means of a network. In this manner, for example, a toy can be remotely controlled by a person. Said toy can be used in general at parties, or if a couple is separated from each other and one partner nevertheless wishes to stimulate the other. Such a system is extremely complex, however, and requires a plurality of technical facilities, such as a connection to a network, in order to be used. Particularly when using massage devices for sexual stimulation, however, ease of use is a critical prerequisite. During sexual intercourse, it is not appropriate to operate complex technical devices and is typically also not accepted by the user.

### BRIEF SUMMARY

The object of the present invention is therefore to disclose a partner toy system and a corresponding partner toy, said toy being easy to use and able to be sensibly used by couples during sexual intercourse.

In one or more embodiments, the receiver partner toy includes a massage body for bringing into contact with the body of a user, the massage body being surrounded at least in segments by a silicone casing, a vibratory drive in the massage body for causing the massage body to vibrate, a control unit for controlling the vibratory drive, and an energy source for providing electrical energy to the vibratory drive and the control unit.

The object is achieved for a receiver partner toy of the type indicated above, such that the control unit is adapted for receiving signals or determining data representing a distance from a transmitter partner toy, and is further adapted for controlling the vibratory drive as a function of the distance. The transmitter partner toy is preferably worn by the other partner. In an embodiment described below, the transmitter partner toy is what is known as a penis ring, for example, for wearing by the male partner during sexual intercourse. The receiver partner toy can be worn in this case by a female or male partner and receives signals or determines data representing the distance from the transmitter partner toy. The vibratory drive is controlled depending on said distance. That is, it is preferable, for example, to increase an intensity of the vibration caused by the vibratory drive when the distance is slight, and to reduce the same correspondingly when the distance is greater. The opposite case is also conceivable, however.

The intensity of a vibration is particularly understood to be the frequency and/or amplitude thereof, wherein a high amplitude or high frequency brings about a high intensity.

In this manner, a partner toy is produced for use by a couple during sexual intercourse. When one partner moves closer to the other partner, for example, the vibratory drive is controlled accordingly and the receiver partner toy is vibrated differently.

The signals can thereby be received from an external transmitter, such as the transmitter partner toy. It is conceivable, for example, that the transmitter partner toy measures the distance from the receiver partner toy and then sends the same to the receiver partner toy. It is also conceivable that the control unit independently determines data representing the distance from the transmitter partner toy.

To this end, the receiver partner toy preferably comprises a sensor unit connected to the control unit and adapted for capturing a distance from the transmitter partner toy and for providing signals representing the captured distance to the control unit. It is thereby fundamentally preferable that the sensor unit comprises at least one sensor for capturing electromagnetic or magnetic radiation. The transmitter partner toy correspondingly transmits preferably electromagnetic or magnetic radiation. On the basis of the magnetic or electromagnetic field then generated by the transmitter partner toy, the distance between the transmitter partner toy and receiver partner toy can be determined in a known manner. Any type of electromagnetic radiation is thereby fundamentally conceivable, wherein electromagnetic radiation able to penetrate bodily tissues is particularly preferable. It is also conceivable, for example, to measure a distance on the basis of infrared radiation; however, said radiation is very easily blocked, whereby distance measurement can be impeded. RFID chips, Bluetooth® transmitter, or the like are also preferable It is not necessary that the electromagnetic radiation be able to be transmitted for particularly long distances, because the transmitter partner toy and the receiver partner toy are at a short distance from each other during operation in any case.

It is further preferable that the control unit is set up for determining a change over time of the distance and for controlling the vibratory drive as a function of the change over time of the distance. Not only controlling as a function of the absolute (static) distance is preferable, but also particularly as a function of the change in the distance. It is conceivable, for example, that for a high relative speed of the transmitter partner toy and the receiver partner toy relative to each other, the vibratory drive is controlled so as to cause a vibration having a high intensity. It is also conceivable, for example, that an amplitude of the vibration caused by the vibratory drive is controlled on the basis of an absolute distance and the frequency of the vibration generated by the vibratory drive is controlled on the basis of the change in distance. Other combinations are also conceivable and preferable.

In a preferred refinement, the vibratory drive comprises at least one coil element and at least one displaceably guided ferromagnetic core disposed coaxial to the coil element, wherein the core comprises a mass m1, the mass ratio m1:m2 thereof to the overall mass m2 of the receiver partner toy being in the range from 1:100 to 1:3. Such a vibratory drive is particularly suitable, as said drive can be controlled particularly well. By actuating the coil element accordingly, the magnetic core can be accelerated and positioned arbitrarily, so that both the frequency and the amplitude of the vibration can be adjusted particularly easily. A drive such as is described in EP 2 320 850 B1 is preferably used.

Other drives also comprise conventional vibratory drives, however, having a rotating electric motor and an unbalanced mass, piston-rod drives, conventional vibrator drives, and the like.

In a further preferred embodiment, the sensor unit captures the distance substantially continuously. Substantially continuous capturing in the present should also include particularly clocked sampling, for example at a frequency of 100 Hz. It is not necessary that the sensor unit capture the distance completely continuously, but rather preferably digitally at a particular sampling frequency. The sampling frequency can be in a range from 10 Hz to 10000 Hz, 10 Hz to 1000 Hz, preferably in the range of 100 Hz.

According to a preferred refinement, the control unit is adapted for discretely controlling the vibratory drive as a function of the distance. The control unit preferably comprises a storage unit having a plurality of pre-stored vibration profiles. A corresponding vibration profile is preferably selected as a function of the distance and implemented by the control unit. The same applies preferably to the speed of the change in distance. That is, a plurality of programs are saved, for example, discretely providing a particular vibration frequency for the vibratory drive, wherein a corresponding program is selected as a function of the distance. The selection of the program can change every millimeter, or every centimeter, for example. An even higher resolution is also conceivable, so that a new program is selected every 0.5 mm or less.

It is also conceivable that a completely continuous adapting is implemented according to a specified curve. In this case, a program is preferably provided associating a particular amplitude and/or frequency with a particular distance on the basis of a function, and preferably a function for a relationship between a particular change in distance and a frequency and/or amplitude. Said two functions are preferably saved in a memory of the control unit.

It is also conceivable that the receiver partner toy can execute various programs. For this case, a plurality of functions are preferably saved, so that various functions can be selected by a user for associating a frequency or amplitude with a distance. The functions need not particularly be linear, but rather can define any conceivable curve.

In a further preferred embodiment, the sensor unit comprises at least one magnetic field sensor, preferably a Hall-effect sensor. A Hall-effect sensor is a particularly simple sensor for detecting a magnetic field. In the present embodiment, the transmitter partner toy then preferably comprises magnets, so that the distance of the transmitter partner toy from the receiver partner toy can be measured by means of the Hall-effect sensor.

It is further preferable that the massage body of the receiver partner toy is substantially U-shaped and comprises a first and a second leg, w wherein the first leg is provided for being inserted into a vagina of a user, and the second leg is provided for pressing externally in the region of the clitoris or of the pubic bone. The vibratory drive in the present embodiment is preferably disposed substantially within the first leg and the sensor unit is disposed within the second leg. This has the advantage that the sensor unit is not covered by soft tissue of a user and thus capturing electromagnetic or magnetic radiation of the transmitter partner toy is possible in a simple manner.

Both the first and the second leg can comprise a housing preferably displaceably connected to each other by means of a flexible connecting segment. The first and second housing in the first and second leg preferably each comprise two housing half shells connected to each other. It is also conceivable, however, that only one housing half shell or a cage for the sensor unit is provided. It is also conceivable that the vibratory drive is also supported only by a cage or another reinforcing element. It is not necessary that a housing is provided in both the first and the second leg. The control unit can be housed both in the first and in the second leg, but is preferably provided in the first leg. The control unit preferably comprises a circuit board. A cage or a housing is preferably provided for connecting the circuit board, sensor unit, and the energy store.

The receiver partner toy further preferably comprises a connection for a charging device, so that the energy source can be charged. The connection preferably comprises a first and a second contact or charging point accessible from an outer side of the second leg. The contacts are preferably magnetizable, so that a charging device can be connected to the first and second charging points by means of a magnetic connection.

In a second consideration, the object indicated above is achieved by a system having a transmitter partner toy and a receiver partner toy, wherein the receiver partner toy is implemented according to one of the preceding preferred embodiment of a receiver partner toy according to the first consideration of the invention, and the transmitter partner toy comprises a transmitter device.

The transmitter partner toy can be implemented overall corresponding to the receiver partner toy, and can also comprise a massage body for bringing into contact with the body of a user, the massage body being surrounded at least in segments by a silicone casing, comprising a vibratory drive in the massage body for causing the massage body to vibrate, and a control unit for controlling the vibratory drive, and an energy source for providing electrical energy to the vibratory drive and the control unit. In the present embodiment example, it is possible that the transmitter partner toy also generates a vibration and thus also can stimulate the support of the transmitter partner toy.

In other embodiment examples, the transmitter partner toy is purely passive, but comprises the transmitter device.

The transmitter device preferably comprises a magnetic core. The transmitter device preferably comprises a plurality of magnetic cores, for example two, three, four, five, six, etc. A maximum of 15 magnetic cores are preferably provided.

The magnetic core is preferably implemented as a neodymium magnet and is substantially bar-shaped. The magnetic core or every magnetic core preferably has a diameter of 1 to 10 mm and a length of 3 to 20 mm. The magnetic core or every magnetic core preferably has a diameter of 3 to 8 mm and a length of 5 to 15 mm, particularly preferably a diameter of approximately 6 mm and a length of approximately 10 mm.

Furthermore, the transmitter partner toy preferably comprises a transmitter housing at least partially enclosing the transmitter device. This is preferable particularly when the transmitting unit is implemented as an RFID chip, or as a Bluetooth® transmitter or as a different transmitter for electromagnetic radiation.

In a further preferred embodiment, the transmitter housing is substantially annular. The transmitter housing in the present embodiment is preferably implemented as a penis ring and made of a silicone material.

In preferred embodiment, the transmitter partner toy is made exclusively of a silicone material and a plurality of magnetic cores. This is a particularly simple design of the transmitter partner toy and also leads to low production costs. The receiver partner toy in the present embodiment preferably comprises a Hall-effect sensor, so that the distance from the transmitter partner toy can be captured in a simple manner.

According to a third consideration of the invention, the object indicated above is achieved by a method for controlling a receiver partner toy, preferably a receiver partner toy according to any one of the preferred embodiments described above of a receiver partner toy according to the first consideration of the invention, wherein the method comprises the steps: determining a distance between the receiver partner toy and a corresponding transmitter partner toy; controlling a vibratory drive of the receiver partner toy as a function of the determined distance.

It should be understood that the receiver partner toy according to a first consideration of the invention, the system having the transmitter partner toy according to the second consideration of the invention, and the method for controlling a receiver partner toy according to the third consideration of the invention comprise identical and similar considerations as are particularly recorded in the dependent claims. In this respect, full reference is made to the description above, particularly for preferred embodiments of the receiver partner toy, the transmitter partner toy, and the system. The same also applies for advantages and effects of said considerations.

Embodiments of the invention are described below using the drawings. Said drawings are not necessarily intended to depict the embodiments to scale; rather, the drawings are shown in schematic and/or slightly distorted form for explanatory purposes.

With respect to supplements to the teachings directly discernable from the drawings, reference is made to the applicable prior art. It must thereby be considered that various modifications and changes relating to the shape and detail of an embodiment can be made without deviating from the general idea of the invention. The features of the invention disclosed in the description, in the drawings, and in the claims can be essential to the refinement of the invention individually and in any arbitrary combination. All combinations of two or more features disclosed in the description, the drawings, and/or the claims also fall within the scope of the invention. The general idea of the invention is not limited to the precise form or the detail of the preferred embodiments shown and described below or limited to a subject-matter that would be limited in comparison with the subject-matter claimed in the claims. Where dimensional ranges are indicated, values within the stated limits should also be disclosed as limit values and arbitrarily usable and claimable. For simplicity, identical reference numerals are used below for identical or similar parts or parts having identical or similar functions.

### BRIEF DESCRIPTION OF THE SEVERAL VIEWS OF THE DRAWINGS

Further advantages, features, and details of the invention result from the below description of the preferred embodiments and from the drawings, which show:

FIG. 1 is a schematic view of a system comprising a receiver partner toy and a transmitter partner toy;

FIG. 2 is a schematic view of a transmitter partner toy according to a first embodiment example;

FIG. 3 is a schematic view of a transmitter partner toy according to a second embodiment example; and

FIG. 4 is a schematic view of a receiver partner toy.

### DETAILED DESCRIPTION

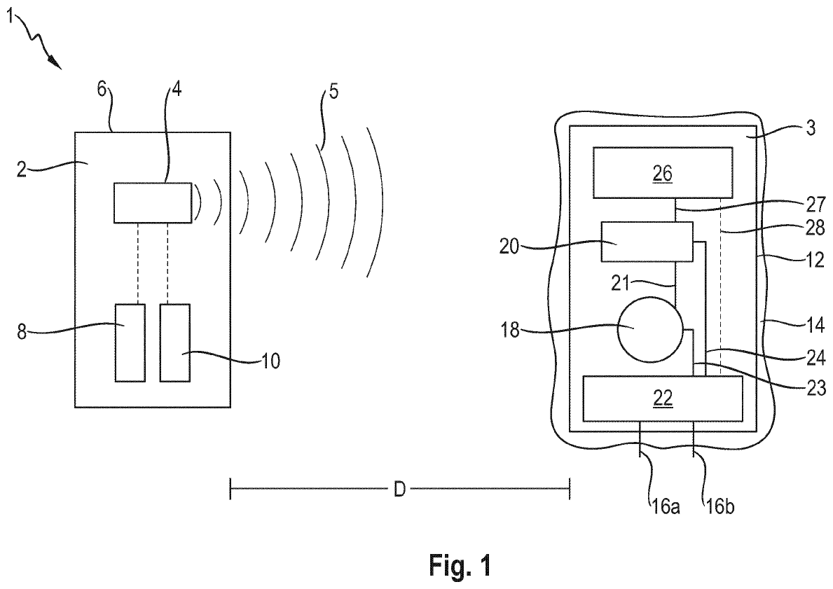

FIG. 1 first schematically shows a system 1 having a transmitter partner toy 2 and a receiver partner toy 3. The transmitter partner toy 2 and the receiver partner toy 3 are spaced apart at a variable distance D in the present embodiment example.

The transmitter partner toy 2 according to the present embodiment example comprises a transmitter device 4 provided for emitting electromagnetic radiation or magnetic radiation 5. The transmitter device 4 is disposed within a housing 6 enclosing the transmitter device 4. The housing 6 can be made of a plastic material or a silicone material or both. Plastic housings at least partially, preferably completely surrounded by a silicone material are preferred, for example.

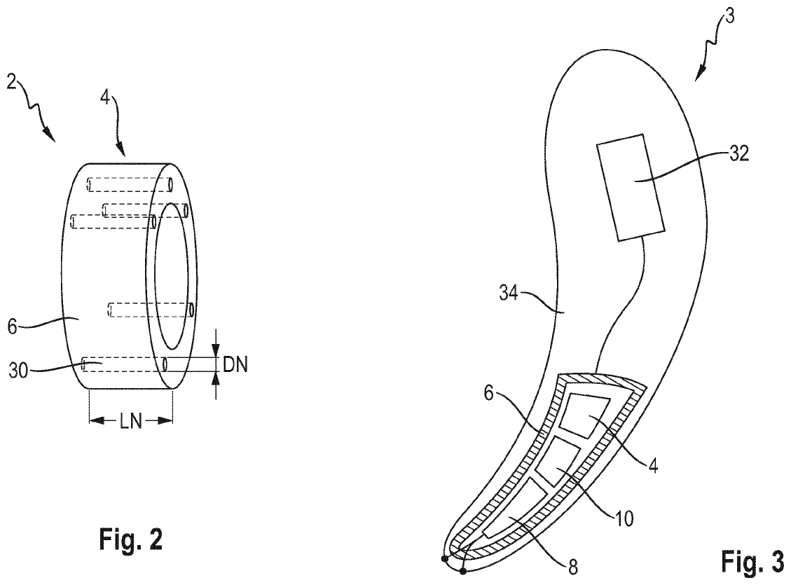

In the schematic view shown in FIG. 1, the transmitter partner toy 2 further comprises an energy source 8 and a transmitter partner toy control unit 10. The latter two elements are necessary only if the transmitter device 4 requires electrical energy for operating. The transmitter device 4 can also be made exclusively of magnets (cf. in FIG. 2) requiring no electrical power for operating. In this case, neither the energy source 8 nor the transmitter partner toy controller 10 are necessary.

In the embodiment example shown in FIG. 1, the controller can be implemented as an RFID chip, as a Bluetooth® transmitter, or the like, for example.

The receiver partner toy 3 also comprises a housing 12, potentially also made of silicone material or surrounded by the same. The housing then forms the massage body. A silicone casing 14 completely enclosing the housing 12 is shown in FIG. 1. It can also be provided that the silicone casing 14 does not completely enclose the housing, particularly exposing in the region of the charging points 16a, 16b. It can thus be provided that the receiver partner toy 3 is provided only for being partially inserted in the vagina, or placed on the body, but not entirely. In this case, the segment inserted into the vagina is preferably surrounded by the silicone casing 14, while another segment for handling is exposed.

The silicone material of the silicone casing 14 is preferably a medical silicone. Said material preferably has a SHORE A hardness in the range of 20-60. It can also be provided that the silicone casing 14 itself comprises various segments having various silicone materials or has various wall thicknesses. It is preferable, for example, that a tendentially lower SHORE hardness and a greater wall thickness is used for a receiver partner toy for inserting, while for receiver partner toys 3 intended only for placing on the body, for example in the region of the clitoris, a higher SHORE hardness and a lower wall thickness are preferred.

The receiver partner toy 3 further comprises a vibratory drive 18 in the massage body 12 for causing the massage body 12 to vibrate, A control unit 20 for controlling the vibratory drive 18 is further provided. The control unit 20 is connected to the vibratory drive 18 by means of an electrical line 21 in order to transmit corresponding signals to the vibratory drive 18. The receiver partner toy 3 further comprises an energy source 22 implemented in the present embodiment example as a rechargeable battery. The energy source is particularly implemented as a lithium-ion rechargeable battery. The energy source 22 is connected to the charging points 16a, 16b for charging the energy source 22. The energy source 22 is connected to the vibratory drive 18 by means of an electrical line 23 and the energy source is connected to the control unit 20 by means of an electrical line 24.

In the present embodiment example, the receiver partner toy 3 further comprises a sensor unit 26. The sensor unit 26 can comprise a plurality of sensors, such as a Hall-effect sensor, a receiver for radio-frequency radiation of an RFID chip, a Bluetooth® receiver, an acceleration sensor, a temperature sensor, an infrared sensor, a gyroscope, a 3D magnetic field sensor, a WiFi receiver, a near-field chip, or the like.

The control unit 20 is connected to the sensor unit 26 by means of a signal line 27. The sensor unit 26 is further optionally connected to the energy source 22 by means of an electrical line 28.

The sensor unit 26 is provided for capturing the electromagnetic or magnetic waves 5 and for determining the distance D on the basis of the captured waves 5. The sensor unit 26 then provides corresponding signals by means of the line 27 to a control unit 20 controlling the vibratory drive 18 as a function of the distance D.

In alternative embodiments, it is also possible that the transmitter partner toy 2 determines the distance D and then wirelessly transmits the same directly to the control unit 20 of the receiver partner toy 3, for example. For this case, the sensor unit 26 is not necessary. The transmitter partner toy control unit 10 would determine the distance D for the present case.

The control unit 20 can be provided for controlling the vibratory drive 18 at a small distance D such that a high intensity, that is, a high amplitude and/or high frequency, is achieved. The control unit 20 preferably comprises a memory in which one or more functions are stored, representing a relationship between the distance D and a vibration to be controlled by means of the vibratory drive 18. Said functions need not necessarily be linear, but can also be second, third, or fourth degree or exponential functions. Said functions can comprise various maxima. It is also possible to discretely select a fixed vibration as a function of a distance, comprising a fixed amplitude and a fixed frequency.

FIG. 2 shows a particularly simple embodiment of a transmitter partner toy 2. The transmitter partner toy 2 comprises a housing 6 and a transmitter device 4 made of a plurality of neodymium magnets 30 in the present embodiment example. The housing 6 corresponds to a penis ring and is made of a silicone material. The silicone material is preferably medical silicone material having a SHORE A hardness in the range of 20-60. The neodymium magnets 30 are completely incorporated in the silicone material of the housing 6 and have a diameter DN in the range of 3-8 mm and a length LN in the range of 2 mm to 10 mm. In the present embodiment example, five neodymium magnets 30 are shown, even though a total of more can be provided. At least four are preferably provided, approximately equally distributed about the circumference of the housing 6. The neodymium magnets 30 in the present embodiment example have a concrete diameter of 6 mm and a length of 10 mm.

FIG. 3 illustrates a somewhat more complex embodiment of a transmitter partner toy 2. The transmitter partner toy 2 according to the present second embodiment example (FIG. 3) comprises a transmitter partner toy vibratory drive 32. The transmitter partner toy 2 is thereby also able to generate vibrations. The transmitter partner toy 2 according to the second embodiment example is suitable for inserting, for example. In this manner, particularly for same-sex sexual activity, stimulation is possible in a particular manner.

This is a substantial difference form the first embodiment example (FIG. 2). The transmitter partner toy in turn comprises a housing 6 substantially completely surrounded by a silicone casing 34 in the present embodiment example. An energy source 8, a transmitter partner toy control unit 10, and a transmitter device 4 are disposed within the housing 6 (as already known from FIG. 1). The transmitter partner toy control unit 10 is further set up for controlling the transmitter partner toy vibratory drive 32 in the present embodiment example (FIG. 3). The transmitter partner toy control unit 10 is preferably set up for controlling the transmitter partner toy vibratory drive 32 as a function of the distance D. To this end, the transmitter partner toy control unit 10 can have a transmitter partner toy sensor unit implemented for matching with the sensor unit 26 of the receiver partner toy. Alternatively, it can also be provided that the receiver partner toy 3 wirelessly transmits the determined distance D to the transmitter partner toy 2, so that the transmitter partner toy control unit 10 can control the transmitter partner toy vibratory drive 32 as a function of the distance D. It is also possible that the control unit 20 of the receiver partner toy 3 wirelessly transmits control signals to the transmitter partner toy control unit 10, said unit then controlling the transmitter partner toy vibratory drive 32 accordingly.

The transmitter partner toy 2 shown in FIG. 3 can also be used as a receiver partner toy. One single resulting design difference is that instead of the transmitter device 4, a sensor unit 26 is provided. Otherwise there are no design differences.

The receiver partner toy 3 according to the second embodiment example (FIG. 3) is substantially crescent-shaped or eggplant-shaped and tapers down in the region of the housing 6. The segment of the silicone casing 34 in which the transmitter partner toy vibratory drive 32 is present serves for inserting into a bodily orifice, such as the vagina or other bodily orifice. The housing 6 achieves reinforcement, such that the region in the housing 6 can be used particularly suitably as a handle. It should be understood that control elements such as control buttons and the like can also be provided on the housing 6. Such control buttons particularly comprise an on/off button and program selection buttons and various programs for controlling the transmitter partner toy vibratory drive 32.

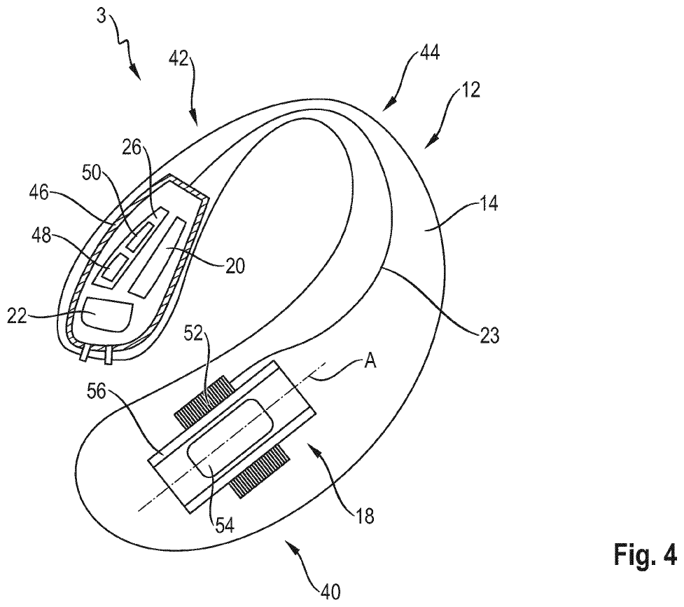

FIG. 4 illustrates a further embodiment example of a receiver partner toy 3. The receiver partner toy 3 shown therein comprises a substantially U-shaped configuration having a first leg 40 and a second leg 42 connected to each other by means of a connecting segment 44. The connecting segment 44 is flexible, while the first and second legs 40 and 42 can be fixed in shape. The first leg 40 is provided for being inserted into a vagina and the second leg 42 is provided for pressing in the region of the clitoris or in the region of the pubic bone.

A housing 46 is provided in the second leg 42 and encloses part of the electronic components of the receiver partner toy 3. The housing 46 is implemented as a plastic housing made of two housing half shells. The control unit 20, the energy source 22, and the sensor unit 26 are present within the housing 46. Said three elements can be provided together on one circuit board.

The sensor unit 26 in the present embodiment example comprises both a Hall-effect sensor 48 and a receiver for RFID chips or near-field chips 50, in case the transmitter partner toy 2 comprises an RFID chip or a near-field chip instead of the neodymium magnets 30. The receiver partner toy 3 can thus be operated in various transmitter partner toys 2.

The vibratory drive 18 in the present embodiment example (cf. FIG. 4) is not implemented as a simple vibratory drive, but rather as what is known as a pulsator drive. Said drive comprises a coil element 52 and a displaceably guided ferromagnetic core 54 disposed parallel or coaxial to the coil element 52. The core 54 is displaceable along the axis A. To this end, the vibratory drive 18 comprises a sleeve or tube 56 provided with stop magnets or the like at the ends thereof in order to prevent the magnetic core 54 from coming out or striking. The ferro magnetic core 54 comprises a mass m1, the mass ratio m1 to m2 thereof to the overall mass m2 of the receiver partner toy 3 being in a range from 1:100 to 1:3. The concrete ratio in the present embodiment example according to FIG. 4 is in the range of 1:5 to 1:10.

As previously described with respect to FIG. 1, a signal line 23 is provided for transmitting control signals from the control unit 20 to the vibratory drive 18.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus, comprising:
a massage body configured to contact a body of a user;
a silicone casing surrounding at least a portion of the massage body;
a vibratory drive in the massage body configured to vibrate the massage body;
a controller configured to transmit signals to the vibratory drive to control the vibratory drive; and
a power source configured to provide electrical energy to the vibratory drive and the controller,
wherein the controller is configured to receive signals representing a distance of the massage body from a transmitter device, and is further configured to control the vibratory drive as a function of the distance.

2. The apparatus according to claim 1, further comprising:
a sensor in electronic communication with the controller and configured to capture a distance from the transmitter apparatus and to provide signals representing the captured distance to the controller.

3. The apparatus according to claim 1, wherein the controller is configured to determine a change in the distance over time and to control the vibratory drive as a function of the change in the distance over time.

4. The apparatus according to claim 1, wherein the vibratory drive further comprises:
at least one coil element; and
at least one displaceably guided ferromagnetic core disposed coaxial to the coil element, the core having a mass m1 and the apparatus having a mass m2, wherein a mass ratio m1:m2 is in the range from 1:100 to 1:3.

5. The apparatus according to claim 2, wherein the sensor is configured to continuously capture the distance.

6. The apparatus according to claim 1, wherein the controller is configured to discretely control the vibratory drive as a function of the distance.

7. The apparatus according to claim 6, wherein the controller is configured to control an intensity of the generated vibration of the vibratory drive based on the distance.

8. The apparatus according to claim 6, wherein the controller includes a memory having a plurality of pre-stored vibration profiles.

9. The apparatus according to claim 8, wherein the controller is configured to select a predetermined vibration profile as a function of the distance and to activate the vibratory drive to output the selected vibration profile.

10. The apparatus according to claim 1, wherein the sensor is a Hall-effect sensor.

11. The apparatus according to claim 1, wherein the massage body is U-shaped and includes a first and a second leg, wherein the first leg configured to be inserted into a vagina of a user, and the second leg is configured to press externally in a region of a pubic bone.

12. The apparatus according to claim 11, wherein the vibratory drive is disposed within the first leg and the sensor is disposed within the second leg.

13. A system, comprising:
a transmitter apparatus including a transmitter device; and
a receiver apparatus, including:
a massage body configured to contact a body of a user;
a silicone casing surrounding at least a portion of the massage body;
a vibratory drive in the massage body and configured to vibrate the massage body;
a controller configured to transmit signals to the vibratory drive to control the vibratory drive; and
a power source configured to provide electrical energy to the vibratory drive and the controller,
wherein the controller is configured to receive signals representing a distance from the receiver apparatus to the transmitter apparatus, and is further configured to control the vibratory drive as a function of the distance.

14. The system according to claim 13, wherein the transmitter apparatus includes a magnetic core.

15. The system according to claim 13, wherein the transmitter apparatus includes a transmitter housing with the transmitter device at least partially enclosed in the transmitter housing.

16. The system according to claim 13, wherein the transmitter housing has an annular shape.

17. A method for controlling an apparatus, comprising:
determining a distance between the apparatus and a corresponding transmitter apparatus; and
controlling a vibratory drive of the apparatus as a function of the determined distance between the apparatus and the transmitter apparatus.

18. The method of claim 17 wherein controlling the vibratory drive includes capturing a distance between the apparatus and the transmitter apparatus with a sensor and transmitting the captured distance to a controller configured to activate the vibratory drive based, at least in part, on the captured distance.

19. The method of claim 18 further comprising:
determining, via the controller, a change in the distance over time between the apparatus and the transmitter apparatus; and
controlling the vibratory drive, via the controller, as a function of the change in the distance over time.
